(19) United States
(12) Patent Application Publication
(10) Pub. No.: US 2013/0171592 A1
(43) Pub. Date: Jul. 4, 2013

(54) Method and System for Presenting Interactive, Three-Dimensional Tools

(71) Applicant: Logical Choice Technologies, Inc., Lawrenceville, GA (US)

(72) Inventors: Jonathan Randall Self, Doraville, GA (US); Cynthia Bertucci Kaye, Dacula, GA (US); Craig M. Selby, Marietta, GA (US); James Simpson, Atlanta, GA (US)

(73) Assignee: Logical Choice Technologies, Inc., Lawrenceville, GA (US)

(21) Appl. No.: 13/727,450

(22) Filed: Dec. 26, 2012

Related U.S. Application Data
(60) Provisional application No. 61/582,137, filed on Dec. 30, 2011.

(51) Int. Cl. G09B 17/00

(52) U.S. Cl. CPC G09B 17/003
USPC 434/178

(57) ABSTRACT

A system includes an education module (107) that is operable with, includes, or is operable to control three-dimensional figure generation software. The education module (107) is configured to present a three-dimensional interactive rendering (1000) on a display (101) of an electronic device (100). The three-dimensional interactive rendering (1000) can be a game, an interaction scenario, or other image, and can be presented when a user (500) actuates a user actuation target (404). A cut video (800) can be presented after the user actuation target (404) is actuated but before the three-dimensional interactive rendering (1000) is presented to provide a stimulating educational experience to a student.

### CROSS REFERENCE TO PRIOR APPLICATIONS

This application claims priority and benefit under 35 U.S.C. §119(e) from U.S. Provisional Application No. 61/582,137, filed Dec. 30, 2011.

### BACKGROUND

1. Technical Field

This invention relates generally to interactive learning tools, and more particularly to a system and method for teaching with a hand-held electronic device.

2. Background Art

Margaret McNamara coined the phrase “reading is fundamental.” On a more basic level, it is learning that is fundamental. Children and adults alike must continue to learn to grow, thrive, and prosper.

Traditionally learning occurred when a teacher presented information to students on a blackboard in a classroom. The teacher would explain the information while the students took notes. The students might ask questions. This is how information was transferred from teacher to student. In short, this was traditionally how students learned.

While this method worked well in practice, it has its limitations. First, the process requires students to gather in a formal environment and appointed times to learn. Second, some students may find the process of ingesting information from a blackboard to be boring or tedious. Third, students that are too young for the classroom may not be able to participate in such a traditional process.

There is thus a need for a learning tool and corresponding method that overcomes the aforementioned issues.

### BRIEF DESCRIPTION OF THE DRAWINGS

FIG. 1 illustrates a schematic block diagram of one explanatory electronic device suitable for use with one or more embodiments of the invention.

FIG. 2 illustrates a schematic block diagram of another explanatory electronic device suitable for use with one or more embodiments of the invention.

FIG. 3 illustrates a front view of an electronic device presenting on a display a cover of one explanatory electronic interactive book configured in accordance with one or more embodiments of the invention.

FIG. 4 illustrates a front view of an electronic device presenting on a display a story page of one explanatory electronic interactive book configured in accordance with one or more embodiments of the invention.

FIG. 5 illustrates a user actuating a read text user actuation target on an electronic device presenting on a display a story page of one explanatory electronic interactive book configured in accordance with one or more embodiments of the invention.

FIG. 6 illustrates an education module, operable on an electronic device, reading text while the electronic device presents on a display a story page of one explanatory electronic interactive book configured in accordance with one or more embodiments of the invention.

FIG. 7 illustrates a user actuating a play user actuation target on an electronic device presenting on a display a story page of one explanatory electronic interactive book configured in accordance with one or more embodiments of the invention.

FIG. 8 illustrates a front view of an electronic device presenting on a display a first portion of an explanatory cut video configured in accordance with one or more embodiments of the invention.

FIG. 9 illustrates a front view of an electronic device presenting on a display another portion of an explanatory cut video configured in accordance with one or more embodiments of the invention.

FIG. 10 illustrates a front view of an electronic device presenting on a display an explanatory three-dimensional interactive rendering corresponding to indicia in an explanatory electronic book configured in accordance with one or more embodiments of the invention.

FIG. 11 illustrates a front view of an electronic device with a user interacting with a presentation on a display of an explanatory three-dimensional interactive rendering corresponding to indicia in an explanatory electronic book configured in accordance with one or more embodiments of the invention.

FIG. 12 illustrates a front view of an electronic device presenting on a display an explanatory three-dimensional interactive rendering after actuation by a user, the three-dimensional interactive rendering corresponding to indicia in an explanatory electronic book configured in accordance with one or more embodiments of the invention.

FIG. 13 illustrates a front view of an electronic device presenting on a display another story page of one explanatory electronic interactive book configured in accordance with one or more embodiments of the invention.

FIG. 14 illustrates a front view of an electronic device presenting on a display a game story page of one explanatory electronic interactive book configured in accordance with one or more embodiments of the invention.

FIG. 15 illustrates a user actuating a play user actuation target on an electronic device presenting on a display a game story page of one explanatory electronic interactive book configured in accordance with one or more embodiments of the invention.

FIG. 16 illustrates an electronic device presenting on a display an explanatory interactive educational game configured in accordance with one or more embodiments of the invention.

FIG. 17 illustrates a user playing an explanatory interactive educational game by interacting with an electronic device presenting the explanatory educational game on a display in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to using an electronic device with a three-dimensional interactive learning tool system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of providing output from a three-dimensional interactive learning tool system as described herein. The non-processor circuits may include, but are not limited to, a camera, a computer, USB devices, audio outputs, signal drivers, clock circuits, power source circuits, and user input devices. As such, these functions may be interpreted as steps of a method to perform the delivery of output from a three-dimensional interactive learning tool system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a learning tool suitable for use in a hand-held electronic device that juxtaposes images of an interactive educational book with three-dimensional imagery on a display of the electronic device. The three-dimensional imagery is triggered when user actuation targets present along the electronic pages of the interactive electronic book are actuated by a user. The electronic interactive book includes one or more user actuation targets that allow a user to read text on the pages of the electronic book, launch cut videos, launch interactive three-dimensional renderings, and launch educational games. In one or more embodiments, the various “launched” applications occur in predefined orders with predefined requisites that must be completed prior to continuing with the pages of the electronic interactive book. For example, in one embodiment a user must complete a predefined number of tasks in an interactive three-dimensional rendering prior to returning to the next page of the electronic interactive book.

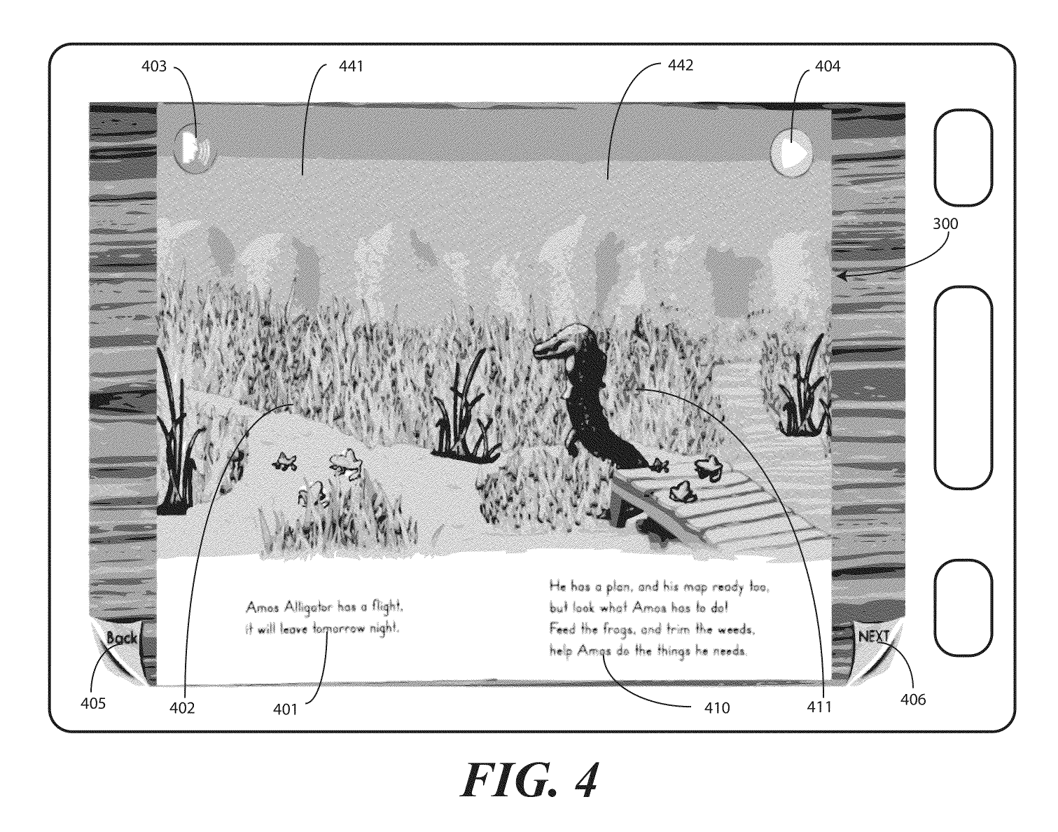

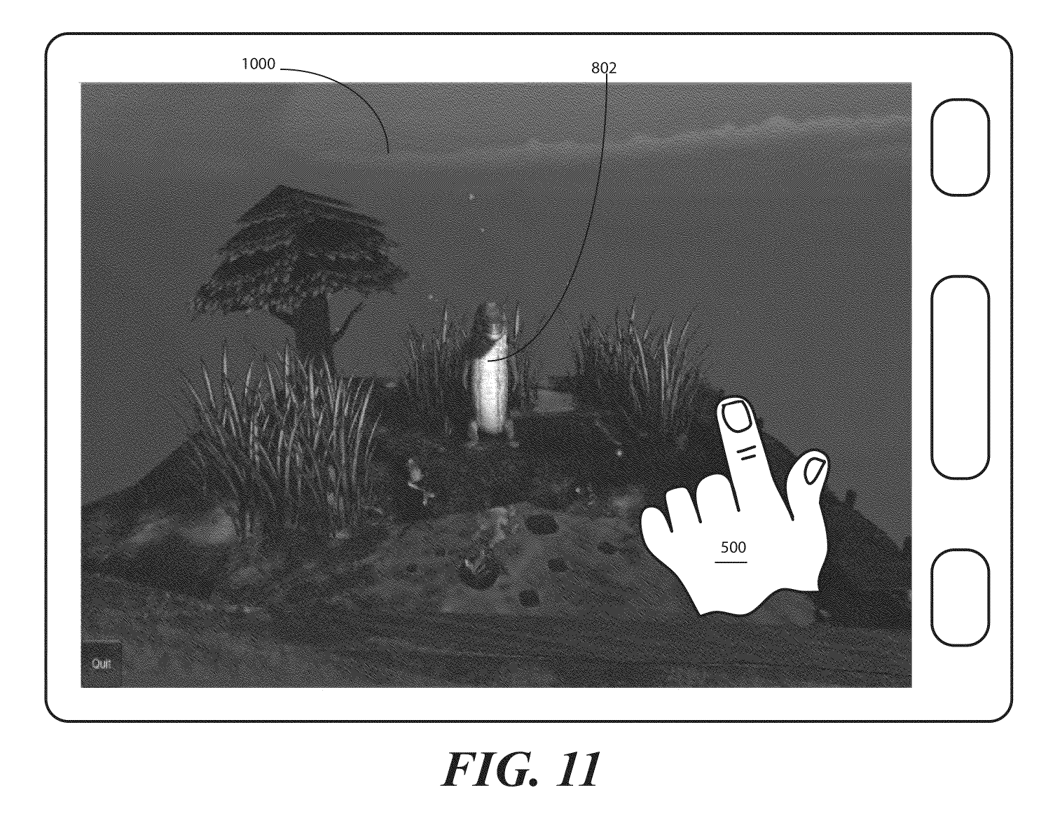

Illustrating by example, the user can actuate a user actuation target to cause an education module operable in the electronic device to read text printed on the currently electronic open page of the electronic interactive book. Additionally, the user can actuate another user actuation target to cause an interactive three-dimensional rendering that corresponds to text and/or graphics present on the currently electronic open page of the electronic book to appear on a display of the electronic device. Once the interactive three-dimensional rendering appears, the user can actuate other user actuation targets to interact with elements of the interactive three-dimensional rendering, thereby making the elements move or respond to gesture input. A combination of prompts to the user, user gestures, and resulting animation of the elements in the interactive three-dimensional rendering can be used to educate the user in the fields of reading, mathematics, science, or other fields. This interaction will be shown in greater detail in the use cases described with reference to FIGS. 4-17 below.

Embodiments of the present invention provide interactive educational tools that combine multiple educational modalities, e.g., visual, gesture, and auditory to form an engaging, exciting, and interactive world for today's student. Embodiments of the invention can comprise interactive electronic books, suitable for downloading to hand-held, palm-top, or laptop electronic devices such as smart phones and tablet computers, which are configured to allow a student to interact with a corresponding educational three-dimensional image to be presented on a computer screen. Additionally, the use of cut videos and interactive games, each of which may be launched only once certain prerequisites have been met in some embodiments, teach learning concepts such as following directions, problem solving, directional sensing, and in one illustrative embodiment, starting an air boat.

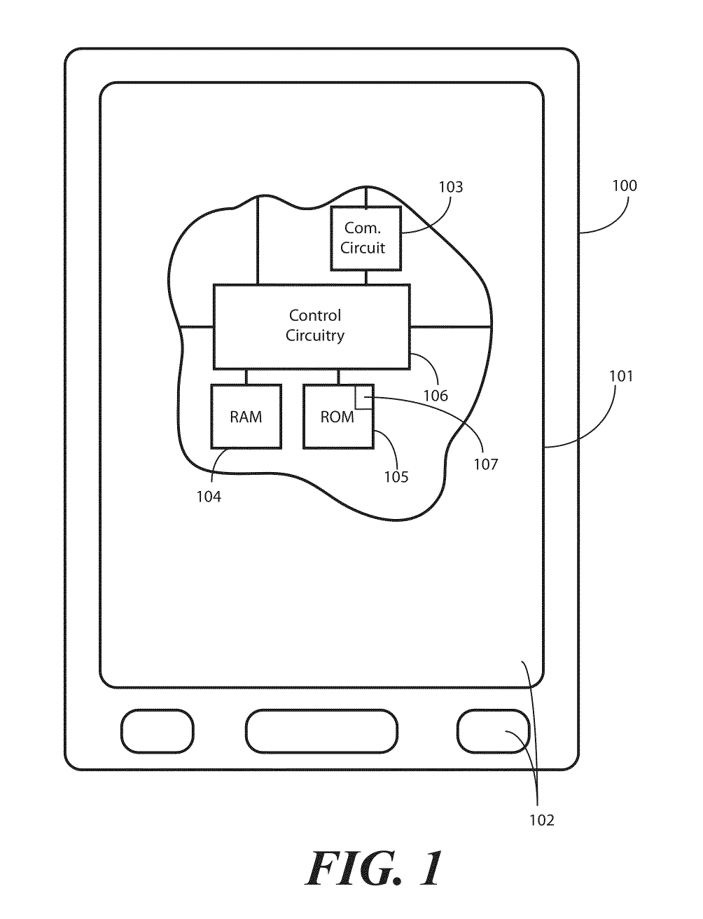

Turning now to FIG. 1, illustrated therein is a schematic block diagram of one explanatory electronic device 100 suitable for using with the modules, programs, and executable instructions configured to execute steps of the methods and systems of embodiments of the present invention. The system of FIG. 1 includes illustrative equipment suitable for carrying out the methods and for constructing the apparatuses described herein. It should be understood that the illustrative system is used as one explanatory embodiment for simplicity of discussion. Those of ordinary skill in the art having the benefit of this disclosure will readily identify other, different systems with similar functionality that could be substituted for the illustrative equipment described herein.

Examples of electronic devices suitable for use as electronic device 100 include iPod®, iPhone®, or iPad® devices manufactured by Apple Inc., of Cupertino, Calif., cellular telephones or messaging devices such as the Blackberry® manufactured by Research in Motion, Inc., pocket-sized personal computers such as an iPAQ® Pocket PC available by Hewlett Packard Inc., palm-top and tablet style computers running the Android® operating system, such as those manufactured by HTC, Inc., and Motorola, Inc., or any of the other various personal digital assistants, desktop computers, laptop computers, or other electronic devices.

As shown in FIG. 1, the electronic device 100 can include a display 101, a user input 102, optional communication circuitry 103, one or more memory devices 104,105, and one or more control circuits 106. As will be obvious to those of ordinary skill in the art having the benefit of this disclosure, in some embodiments the electronic device 100 may include other components such as an audio output component, a power supply, ports or interfaces for coupling to a host devices, a secondary input mechanisms, or other components.

The display 101 can include a visual output device or projection system configured to provide visible output to a user. One example of a suitable display is a liquid crystal display device. Another is an organic light emitting diode device. In one embodiment, the display 101 includes a touch-sensitive device, such as a capacitive touch sensor that is incorporated into the display 101. The display 101 can be movable. The display 101 can include a projection device. The control circuitry 106, described in more detail below, can be operable with the display 101 to present content to the user.

The user input 102 can be configured to receive touch, voice, gesture, or other input from a user. The user input 102 can be configured as one or more buttons, keys, dials, click wheels, or as noted above, as a touch screen. One example of a touch screen is provided in U.S. Pat. No. 7,859,521 to Hotelling et al., which is incorporated herein by reference. In one or more embodiments, the user input 102 can include a device wired or wirelessly coupled to the display 101 or communication circuit 103. For example, the user input 102 may include a keyboard, keypad, mouse, remote controller, voice-instruction apparatus, or other device configured to receive input. The user input 102 can allow a user to manipulate the electronic device 100 and educational programs described herein.

The control circuit 106 is operable to control operations and performance of the electronic device 100. The control circuit 106 can be configured as one or more processors operable with a bus configured for sending instructions to the other components of electronic device 100. In one embodiment, a communication bus, shown illustratively with black lines in FIG. 1, permits communication and interaction between the various components of the device 100. The communication bus enables components to communicate instructions to any other component of the device 100 either directly or via another component.

The control circuit 106 can be operable with the memory devices 104,105, or other components suitable for controlling operations of electronic device 100. The control circuit 106 can execute operational instructions configured as modules and executable code stored within the memory devices 104,105. In some embodiments, the control circuit 106 can be operable with the display 101 and may drive the display 101 and/or process inputs received from the user input 102. The control circuit 106 can be a microprocessor, combination of processors, or other type of computational processor, and in one embodiment retrieves executable instructions stored in the memory devices 104,105. For example, the control circuit 106 may include “general purpose” microprocessors, a combination of general and special purpose microprocessors, instruction set processors, graphics processors, video processors, and/or related chips sets, and/or special purpose microprocessors. The control circuit 106 also may include on board memory for caching purposes.

The memory devices 104,105, as well as any other included storage devices, can be configured as cache, Flash, one or more of a read-only memory (ROM) or random-access memory (RAM). In some embodiments, memory may be specifically dedicated to storing firmware for device applications such as an operating system, user interface functions, and processor functions.

The control circuit 106 can use executable instructions to control and direct execution of the various components. For example, when the electronic device 100 is turned ON, the control circuit 106 may retrieve one or more programs stored in a nonvolatile memory to initialize and activate the other components of the system. The executable instructions can be configured as software or firmware and can be written as executable code. In one embodiment, the ROM memory device 105 may contain select programs used in the operation of the electronic device 100. The RAM memory device 104 can contain registers that are configured to store information, parameters, and variables that are created and modified during the execution of the operating system and programs.

The electronic device 100 can optionally also include other elements, including a hard disk to store programs and/or data that has been processed or is to be processed, a keyboard and/or mouse or other pointing device that allows a user to interact with the electronic device 100 and programs, a remote control, one or more additional communication interfaces adapted to transmit and receive data with one or more devices or networks, and memory card readers adapted to write or read data.

The electronic device 100 may include a video capture device, such as a camera. The camera, in one embodiment, is can be any type of computer-operable camera having a suitable frame capture rate and resolution. For instance, in one embodiment the camera is an integral component of the electronic device.

An education module 107, which can include an integrated a three-dimensional figure generation or rendering program, is configured to detect actuation of user actuation targets presented on the display 100. The education module 107 can be configured as a downloadable application or “app” suitable for execution by the control circuit 106. The education module 107 can be configured as stand-alone software, suitable for storage in any of a number of computer readable media for execution by any number of processing devices. The education module 107 can control the various functions of the system, including an audio output program and/or the three-dimensional figure-rendering program to present educational output to the user on the display 101 and/or audio output devices. In one embodiment, the educational output comprises a two-dimensional representation of an educational three-dimensional object and/or interactive scene.

In one embodiment, the audio output program of the education module 107 is configured to deliver audio output corresponding to text or graphics on currently open electronic pages of an electronic interactive book in response to user actuation of a predefined user actuation target disposed on the currently opened electronic page. In another embodiment, the three-dimensional figure rendering program of the education module 107 can be configured to generate the two-dimensional representation of the educational three-dimensional object in response to the education module 107 detecting that a user has actuated another user actuation target present on the currently opened electronic pages. In yet another embodiment, the three-dimensional figure-rendering program of the education module 107 can be configured to retrieve predefined three-dimensional objects from the ROM memory device 105 or the RAM memory device 104 in response to instructions from the education module 107.

In one embodiment, the educational three-dimensional object presented on the display 101 is an interactive scene that corresponds to one or more detected characters, objects, text lines, or images disposed on the electronic pages of the electronic interactive book 400. For instance, an educational, three-dimensional, interactive scene can be related to text, graphics, or indicia on currently opened electronic pages by a predetermined criterion. Where the displayed characters, objects, or images comprise one or more words, the education module 107 can be configured to read the words when a user actuates an actuation target present on the page configured to “make the computer read the text. Other techniques for triggering the presentation of three-dimensional educational images on a display 101 will be described herein.

In one embodiment, the education module 107, and optionally the three-dimensional figure rendering program and audio output program, can be stored in an external device, such as a USB card, which is configured as a non-volatile memory. In such an embodiment, the control circuit 106 may retrieve the executable code comprising the education module 107, the audio output program, and three-dimensional figure-rendering program through a card interface when the read-only USB device is coupled to the card interface. In one embodiment, the control circuit 106 controls and directs execution of the instructions or software code portions of the program or programs of the interactive three-dimensional learning tool.

In one embodiment, the education module 107 includes an integrated three-dimensional figure generation program and an integrated audio output program. Alternatively, the education module 107 can operate, or be operable with, a separate three-dimensional figure generation program and an audio output program that is integral with the electronic device 100. Three-dimensional figure generation programs, which are sometimes referred to as an “augmented reality programs,” are available from a variety of vendors. For example, the principle of real time insertion of a virtual object into an image coming from a camera or other video acquisition means using that software is described in patent application WO/2004/012445, entitled “Method and System Enabling Real Time Mixing of Synthetic Images and Video Images by a User.” In one embodiment, three-dimensional figure generation program, such as that manufactured by Total Immersion under the brand name D'Fusion®, is operable on the control circuit 106 of the electronic device 100.

In one embodiment of a computer-implemented method of teaching reading using the education module 107, a user interacts with one or more “virtual” open pages of an electronic interactive book. The pages can include graphics, text, user actuation targets, or other visible elements. The pages can additionally be photographs, pictures, or other graphics.

In one embodiment, the various visible objects disposed on the pages can be correlated with a predetermined educational function. For example, a user actuation target can be correlated with a “present interactive three-dimensional rendering” function, a “present gaming scenario” function, or a “read text” function. When a user touches or otherwise actuates the user actuation target with a hand, stylus, or other object, the education module 107 can be configured to execute the corresponding function.

The education module 107, by controlling, comprising, or being operable with the audio output program and the three-dimensional figure generation program, then augments image data for presentation on the display 101 in response to interaction events initiated by the user. For example, in one embodiment, a user actuation target corresponds to the presentation of a three-dimensional, interactive rendering on the display 101 of the electronic device 100. Accordingly, the education module 107 can be configured to superimpose a two-dimensional representation of an educational three-dimensional interaction object on an image of the electronic interactive book, or alternatively replace the image of the electronic interactive book with the three-dimensional interaction object by presenting the augmented image data on the display 101. In the former embodiment, to the user, this appears as if a three-dimensional rendering has suddenly “appeared” and is sitting atop the image of the electronic interactive book. In the latter embodiment, to the user, this appears if the electronic book has suddenly transformed into a magical, educational world rich with depth and texture. The user can then interact with the three-dimensional rendering by touching user actuation targets disposed within the three-dimensional rendering.

Illustrating by way of one simple example, in one embodiment the user actuation target present on an electronic interactive book is a “play icon,” which can be configured as a rightward facing triangle in a circle. When the user actuates this play icon with a hand, stylus, mouse, or other object, the education module 107 detects this. The education module 107 then augments the one or more video images by causing the three-dimensional figure generation program to superimpose a two-dimensional representation of an educational three-dimensional interactive rendering on an image of the electronic interactive book, or alternatively replace the image of the electronic interactive book with the two-dimensional representation of the educational three-dimensional interactive rendering. In either case, the educational three-dimensional interactive rendering is presented on the display 101.

Using one simple example as an illustration, a particular page of the interactive book used in explanatory embodiments shown in the figures below may be describing a character called “Amos Alligator” as he gets ready for a trip. When the user touches the play icon on the display 101, presuming a touch-sensitive display, a three-dimensional interactive rendering of Amos standing at his home in a swamp may be presented. In one embodiment, the three-dimensional interactive rendering is a high-definition three-dimensional environment corresponding to an illustration on the open pages of the electronic interactive book.

The education module 107 may then have elements of the three-dimensional interactive rendering prompt a user for inputs. For example, the education module 107 may have Amos say, via a loudspeaker of the electronic device 100, “Please tell me what I need to do before I leave?” Or, alternatively the education module 107 may have Amos say, “I need to cut my grass and feed my frogs before I leave. How do I do that?”

The user may then touch other user actuation targets on the display 101 to control Amos's actions. For example, the user may touch an illustration of switch grass on the three-dimensional interactive rendering. When this occurs, the education module 107 detects this gesture and causes Amos to slash his tail across the selected grass, thereby cutting it. Similarly, the user may touch one of Amos's frogs that are present in the three-dimensional interactive rendering. Accordingly, the education module 107 may cause Amos to open a jar of flies and feed the selected frog.

In one embodiment, once the various tasks are complete, the three-dimensional interactive rendering may automatically be removed. In another embodiment, a user may cause the three-dimensional interactive rendering to disappear by actuating a predetermined user actuation target.

In one embodiment, an interactive element present in the three-dimensional interactive rendering 181 can be an animal. The animal can be a giraffe, gnu, gazelle, goat, gopher, groundhog, guppy, gorilla, or other animal. By superimposing a two-dimensional representation of a three-dimensional rendering of the animal on the three-dimensional interactive rendering, it appears—at least on the display 101—as if a three-dimensional animal is sitting or standing atop the three-dimensional interactive rendering. The system of FIG. 1 and corresponding computer-implemented method of teaching provides a fun, interactive learning system by which students can learn the alphabet, how to read, foreign languages, and so forth. The system and method can also be configured as an educational game.

The electronic interactive book can be configured as a series of books, each focusing on a different letter of the alphabet. Where letters and animals are used as the main character, the letter and the animal can correspond by the animal's name beginning with the letter. For example, the letter “A” can correspond to an alligator, while the letter “B” corresponds to a bear. The letter “C” can correspond to a cow, while the letter “D” corresponds to a dolphin. The letter “E” can correspond to an elephant, while the letter “F” corresponds to a frog. The letter “G” can correspond to a giraffe, while the letter “H” can correspond to a horse. The letter “I” can correspond to an iguana, while the letter “J” corresponds to a jaguar. The letter “K” can correspond to a kangaroo, while the letter “L” corresponds to a lion. The letter “M” can correspond to a moose, while the letter “N” corresponds to a needlefish. The letter “O” can correspond to an orangutan, while the letter “P” can correspond to a peacock. The letter “R” can correspond to a rooster, while the letter “S” can correspond to a shark. The letter “T” can correspond to a toucan, while the letter “U” can correspond to an upland gorilla or a unau (sloth). The letter “V” can correspond to a vulture, while the letter “W” can correspond to a wolf. The letter “Y” can correspond to a yak, while the letter “Z” can correspond to a zebra. These examples are illustrative only. Others correspondence criterion will be readily apparent to those of ordinary skill in the art having the benefit of this disclosure.

In one embodiment, the education module 107 can cause audible sounds to emit from the electronic device 100 by way of the audio output program. For example, when text appears on a particular page of the electronic interactive book, actuating a “read the text” user actuation target can cause the education module 107 to generate a signal representative of an audible pronunciation of text present on the page. Using the Amos the Alligator example from above, the audible pronunciation may state, “Amos Alligator has a flight. It will leave tomorrow night. He has a plan, and is map is ready too, but look what Amos has to do! Feed the frogs, and trim the weeds, help Amos do the things he needs.” This pronunciation can be configured to be suitable for emission from a loudspeaker. Alternatively, phonetic sounds or pronunciations of the name of the building can be generated.

In another audio example, presume that the visible object 151 is the Amos sleeping. In one embodiment, the text may read, “The swamp welcomes the morning bright, but Amos does not like the light. The rooster crows, the birds all sing, but Amos does not hear a thing. Wake up Amos! Time to go, or you will miss your flight, you know!” A voice over may read this text via the audio output program through the loudspeaker. Alternatively, an indigenous sound made by the animal, such as an alligator's roar. This sound may be played in addition to, or instead of, the voice over. Further, ambient sounds for the animal's indigenous environment, such as jungle sounds in this illustrative example, may be played as well.

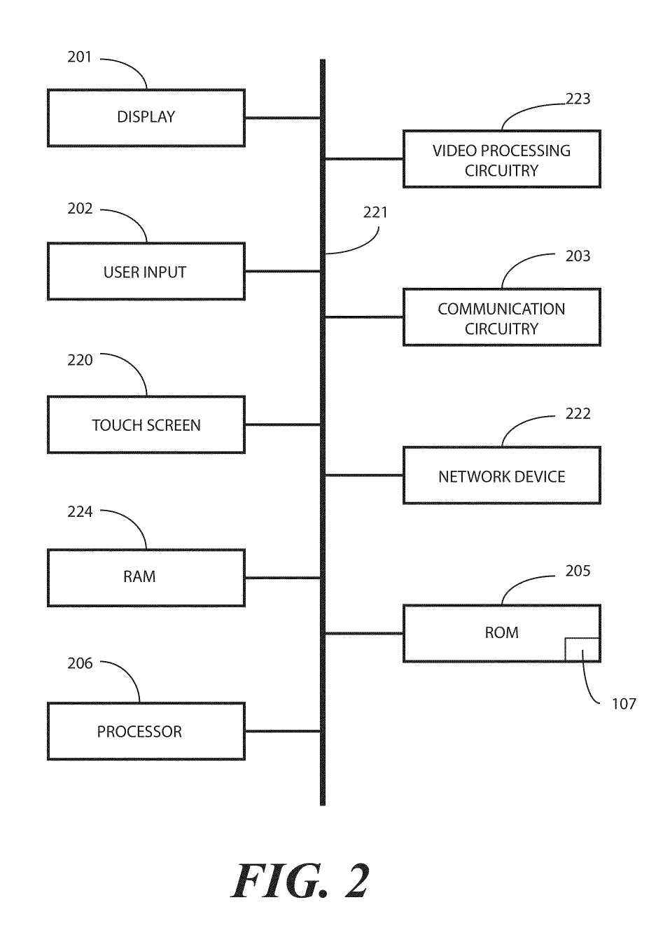

Turning now to FIG. 2, just to illustrate the diversity of platforms upon which the education module 107 can operate, illustrated therein is an alternate block diagram of circuitry suitable for use in the electronic device (100) of FIG. 1. In this illustrative embodiment, the circuitry includes a display 201, user input 202, a touch screen 220, a RAM memory module 204, a ROM memory module 205 containing the education module 107, communication circuitry 203, and a control circuit 206. These elements can operate substantially as described above.

The central bus 221 shown in FIG. 2 can be configured to transmit PIO instructions to the various devices coupled to the central bus 221. The central bus 221 can optionally be used to initiate DMA transfers. Accordingly, the central bus 221 can be configured to facilitate both DMA transfers and direct read and write instructions to and from the control circuit 106.

The RAM memory module 204 can take various forms, such as dynamic RAM and/or synchronous double data rate RAM. The RAM memory module 204 can include non-volatile memory devices, such as ROM, EPROM and EEPROM or some combination of volatile and non-volatile memory. Additionally, the RAM memory module 204 can include a controller configured to control data flow to and from the RAM memory module 204.

The ROM memory module 205 may store data required for the operation of the control circuit 206. Additionally, the ROM memory module 205 can store firmware that is executable by the control circuit 206, such as an operating system, other programs, GUI functions, and/or processor functions. The ROM memory module 205 can store graphical elements, screens, and templates, and additionally media, e.g., music and video files, image data, software, preference information, e.g., media playback preferences, wireless connection information, subscription information, and other suitable data.

As noted above, a user may interact with the education module 107 by touching the graphical elements within a graphical user interface present on the display 201 or touch screen 220. The touch screen 220 may be positioned in front of or behind the display 201 and may be used to select graphical elements presented on the display 201. The touch screen 220 can be configured to receive input from a user's or object's touch, as well as to send the information to the control circuit 206. The control circuit 206 can be configured to interpret the touch event and perform a corresponding action. The touch screen 220 can be configured as a resistive touch sensor, a capacitive touch sensor, an infrared touch sensor, a surface acoustic wave touch sensor, an electromagnetic touch sensor, or a near field imaging sensor. The touch screen 220 can be used in conjunction with or independently of the user input 202 present on the electronic device (100).

A network device 222 can optionally be included for receiving and transmitting information over one or more broadband communications channels. The network device 222 can comprise network interface cards or controllers. The network device 222 can communicate with local area networks, wide area networks, or combinations thereof.

Optional video processing circuitry 223 can be configured to process video data, such as images received from a camera. The video processing circuitry 223 can be configured to compress video data, send uncompressed or decompressed video data, or extract textual or encoded information from an image, such as numbers, symbols, graphics, or letters.

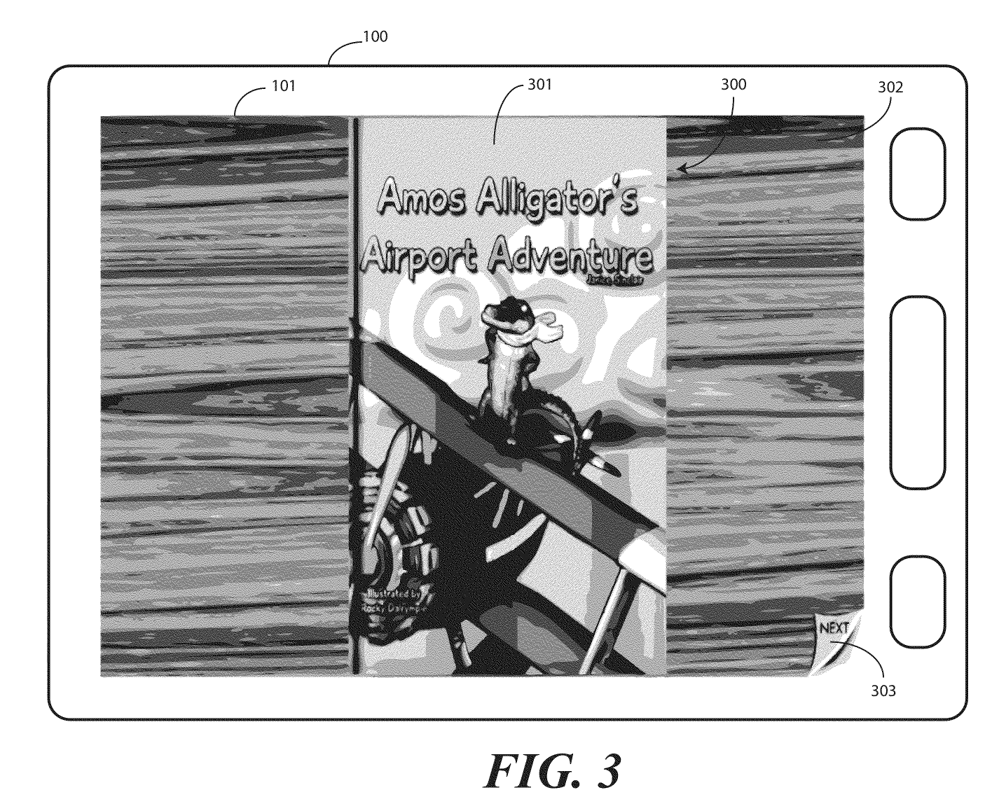

Turning now to FIG. 3, illustrated therein is one initial step of an explanatory computer-implemented method of teaching reading in accordance with one or more embodiments of the invention. For simplicity of discussion, the system is configured as an application for teaching reading and associated instructional concepts, and the computer-implemented method is configured as a computer-implemented method of teaching reading and instructional concepts. However, it will be clear to those of ordinary skill in the art having the benefit of this disclosure that embodiments of the invention could be adapted to teach things other than reading or instructional concepts. For example, the use cases described below could be adapted to teach arithmetic, mathematics, or foreign languages. Additionally, the use cases described below could also be adapted to teach substantive subjects such as anatomy, architecture, chemistry, biology, or other subjects.

As shown in FIG. 3, the front cover 301 of an electronic interactive book 400 is presented on a display 101 of an electronic device 100. The electronic interactive book 400 is called “Amos Alligator's Airport Adventure.” The front cover 301 is shown sitting on a wood grain table 302. A user actuation target 303 is present in the lower-right hand corner of the display 101. Since this display 101 is touch-sensitive, the user can touch the user actuation target 303 to open the electronic interactive book 400. The user actuation target 303 of this illustrative embodiment is configured as a layer of the wood grain “peeling” upward, thus suggesting a page of the electronic book 300 being opened.

Turning to FIG. 4, illustrated therein are explanatory story pages 441,442 of the electronic interactive book 400 once opened. As shown in FIG. 4, the open story pages 441,442 of the electronic interactive book 400 can include text 401,410, art and/or graphics 402,411, and one or more user actuation targets 403, 404, 405, 406. Each of these actuation targets 403, 404, 405, 406 can be correlated with a predefined function. The user actuation targets 403, 404, 405, 406 are configured as icons that can be actuated by a user. When one or more of the user actuation targets 403, 404, 405, 406 is touched, such as when a user's finger is placed atop one of the targets and covers that target, the education module (107) is configured in one embodiment to actuate a multimedia response. The multimedia response can take a number for forms, as the subsequent discussion will illustrate.

In the illustrative embodiment of FIG. 4, user actuation target 403 comprises a “read text” element. User actuation target 404 comprises a “play” element. User actuation targets 405,406 can be interaction targets. In this illustrative embodiment, user actuation target 405 causes the pages 441,442 to be turned to previous pages. User actuation target 406 causes the pages 441,442 to be turned to later pages. The uses of each of these will be described in detail in following figures.

In one embodiment, when the user covers user actuation target 403, the education module (107) reads the text 401,410 on the open pages 441,442 of the electronic interactive book 400. In one embodiment, when the user covers user actuation target 404, the education module (107) augments the one or more video images for presentation on a display by causing the three-dimensional figure generation software to display two-dimensional representation of a three-dimensional interactive rendering of the art and/or graphics 402,411 present on the open pages 441,442 of the electronic interactive book 400.

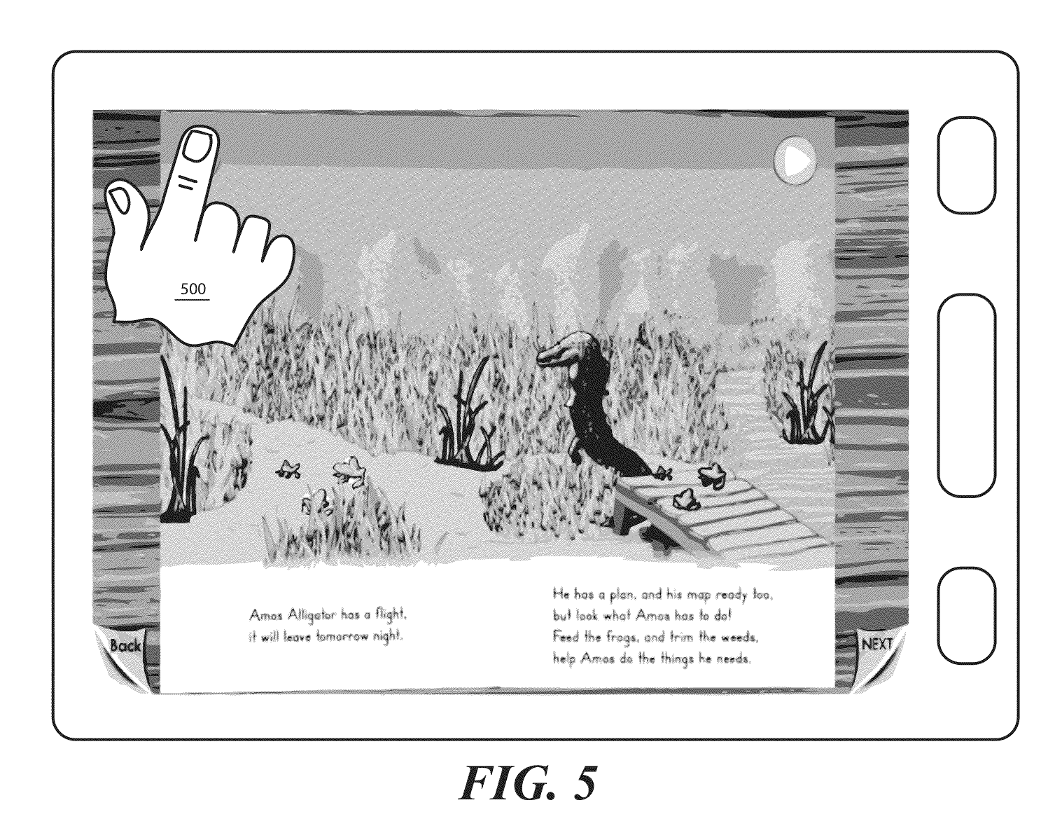

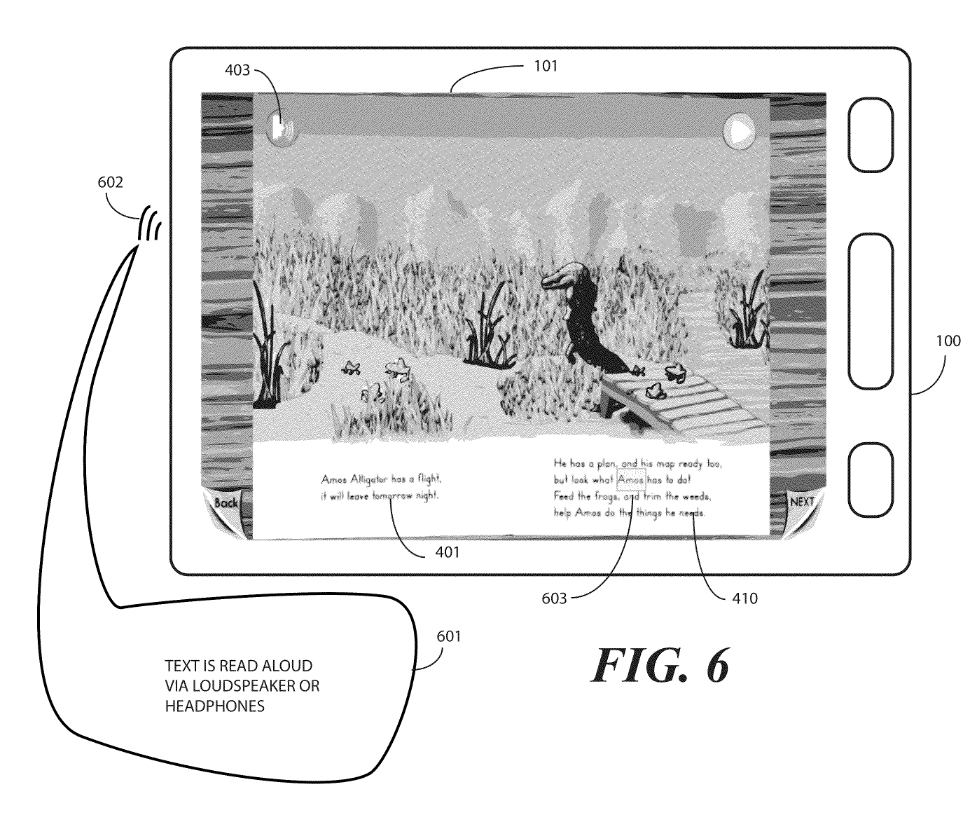

As shown in FIG. 5, the user 500 has covered the “read text” element. As shown in FIG. 6, the education module (107) causes the audio output program to read 601 the text 401,410 out loud via a loudspeaker of the electronic device 100. As shown in FIG. 6, audible sounds 602 are emitted from a loudspeaker. In one embodiment, the text 410 can optionally be highlighted 603 on the display 101 while the text 410 is being read 501. Covering user actuation target 403 allows a student to hear the text 401,410 while it is being read 601. This reinforces the student's knowledge of the pronunciation and meaning of the text 401,410. When highlighting 603 is used, the student understands which pronunciation corresponds with which word of the text 401,410.

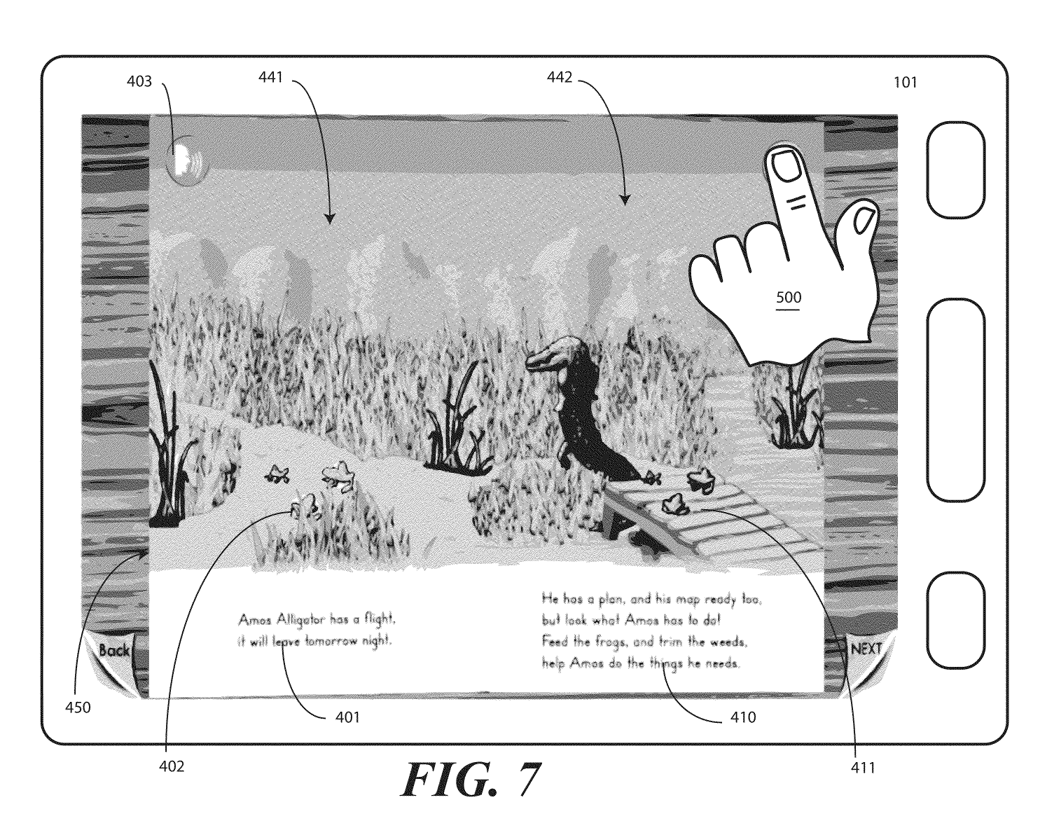

Turning now to FIG. 7, illustrated therein is the user 500 covering the play element of the open pages 441,442 of the electronic interactive book 400. In one embodiment, the functionality of the play element may be precluded until user actuation target 403 has been covered to read the text 401,410 as described above. Said differently, in one embodiment, the education module (107) can be configured to prevent the user 500 from proceeding to an interactive game or other interactive feature by not effecting the function associated with the play element until the user has first covered user actuation target 403. Accordingly, a student must experience the reading lesson before proceeding to the game or interactive portion. In other embodiments, no restrictions are placed on the order in which user actuation 403 and user actuation target (404) can be engaged. In yet another embodiment, the preclusion is user definable such that a parent can, in some instances, require the reading lesson to occur before the interaction portion, while in other instances allowing them to occur in any order.

When the user covers the play element, i.e., user actuation target (404), the education module (107) transforms the displayed image 450 of the pages 441,442 into a three-dimensional interactive session or an interactive game. This can be done, in one embodiment, by superimposing a two-dimensional representation of a three-dimensional rendering of the art and/or graphics 402,411 to appear on the display 101 as if “floating” above the image 450 of the pages 441,442 of the electronic interactive book 400. The user can then interact with the interactive session or game by covering the other user actuation targets present in the three-dimensional rendering. In another embodiment, the education module (107) can replace the pages 441,442 of the electronic interactive book 400 with the three-dimensional rendering.

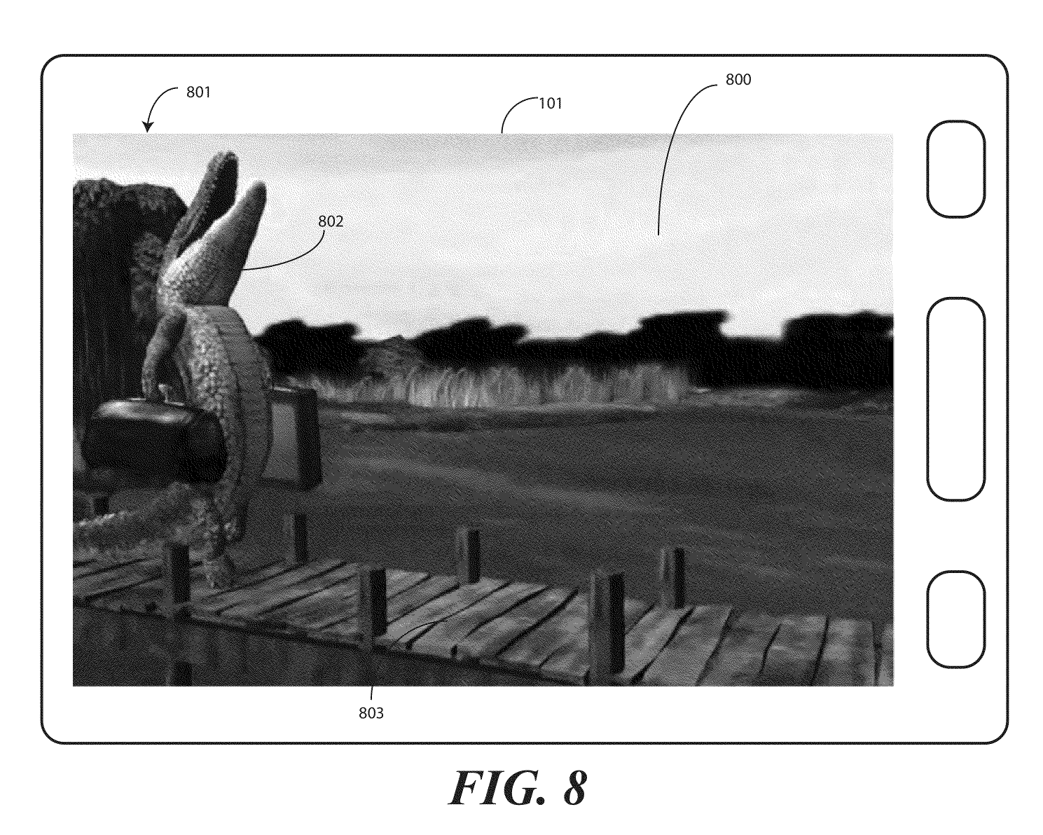

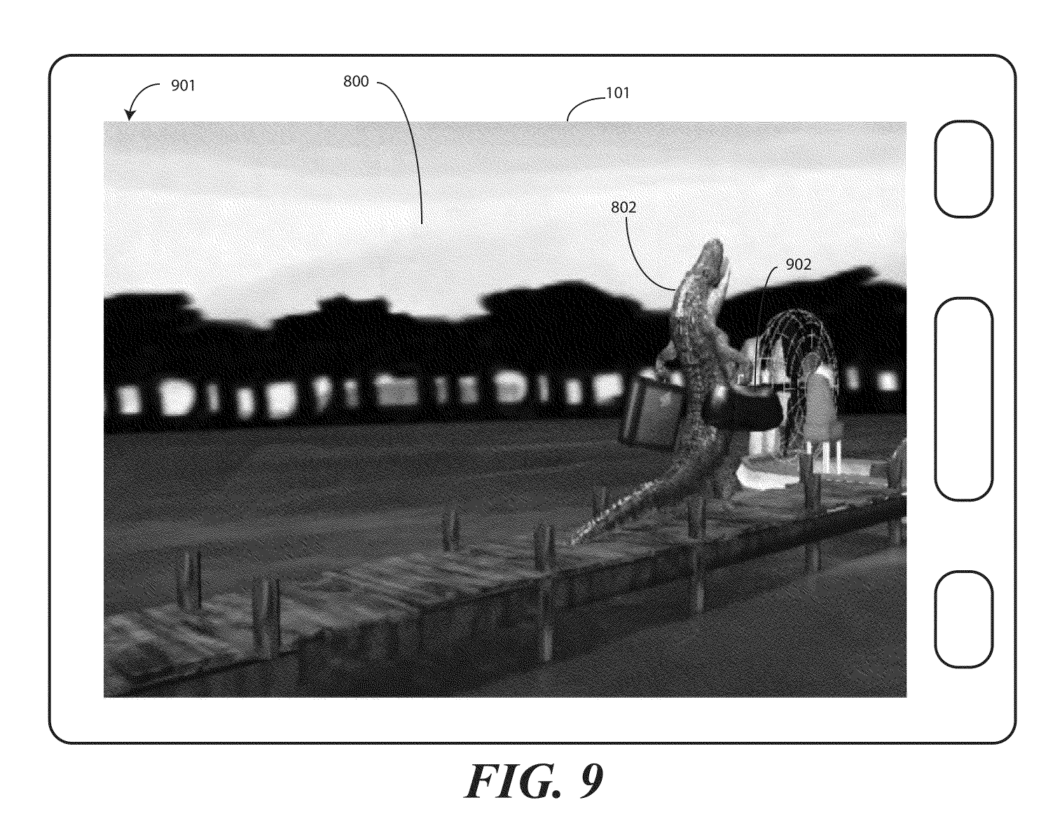

In one embodiment, the interactive session or game appears instantaneously when the user 500 touches the play element. However, to further aid in the teaching process, in one or more embodiments a “cut video” is played after the user 500 covers the play element and before the interactive session or game. As shown in FIGS. 8 and 9, in one embodiment a cut video 800 is presented on the display 101 after the user (500) has covered user actuation element (404).

A cut video 800, in one embodiment, is a clip or short that sets up the interactive session or game that will follow. The cut video 800 can provide a transitional story between the art and/or graphics (402,411) present on the open pages 441,442 of the electronic interactive book 400 and the upcoming interactive session or game. In another embodiment, the cut video 800 may simply be an entertaining video presented between the actuation of user actuation target (404) and the upcoming interactive session or game. For example, where the interactive session is a game where Amos Alligator has to navigate logs along a river in the swamp, the cut video 800 may be a snippet of Amos riding in an airboat. The cut video 800 may show the details of the boat, may show Amos talking about the features of the swamp, and so forth. In the illustrative embodiments of FIGS. 8 and 9, the cut video 800 shows Amos running to catch his airboat. FIG. 8, which shows the starting portion 801 of the cut video 800, shows Amos 802 beginning to run down a dock 803. FIG. 9, which shows an ending portion 901 of the cut video 800, shows Amos 802 arriving at the airboat 902.

In one or more embodiments, the cut video 800 comprises an entertainment respite for the student that fosters encouragement for the student to continue with the book. The more lessons through which the student passes, the more cut videos they will be able to see. In one embodiment, the various cut videos 800 associated with each play element form a supplemental story that is related to, but different from, the story of the electronic interactive book 400. Accordingly, making it through each of the lessons in the open pages 441,442 allows the student to “decode the mystery” of learning what story is told by the cut video 800 clips. In one embodiment, the cut video 800 is presented as a full-screen image on the display 101. In another embodiment, the cut video 800 can be presented as an element that appears to float over the image (450) of the electronic interactive book 400 present on the display 101.

Once the cut video 800 has completed, or in another embodiment immediately after the user (500) has covered user actuation target (504), the education module (107) can superimpose the three-dimensional interactive rendering on the image of the electronic interactive book (400). Alternatively, the education module (107) can replace images of the electronic interactive book (400) with the three-dimensional rendering.

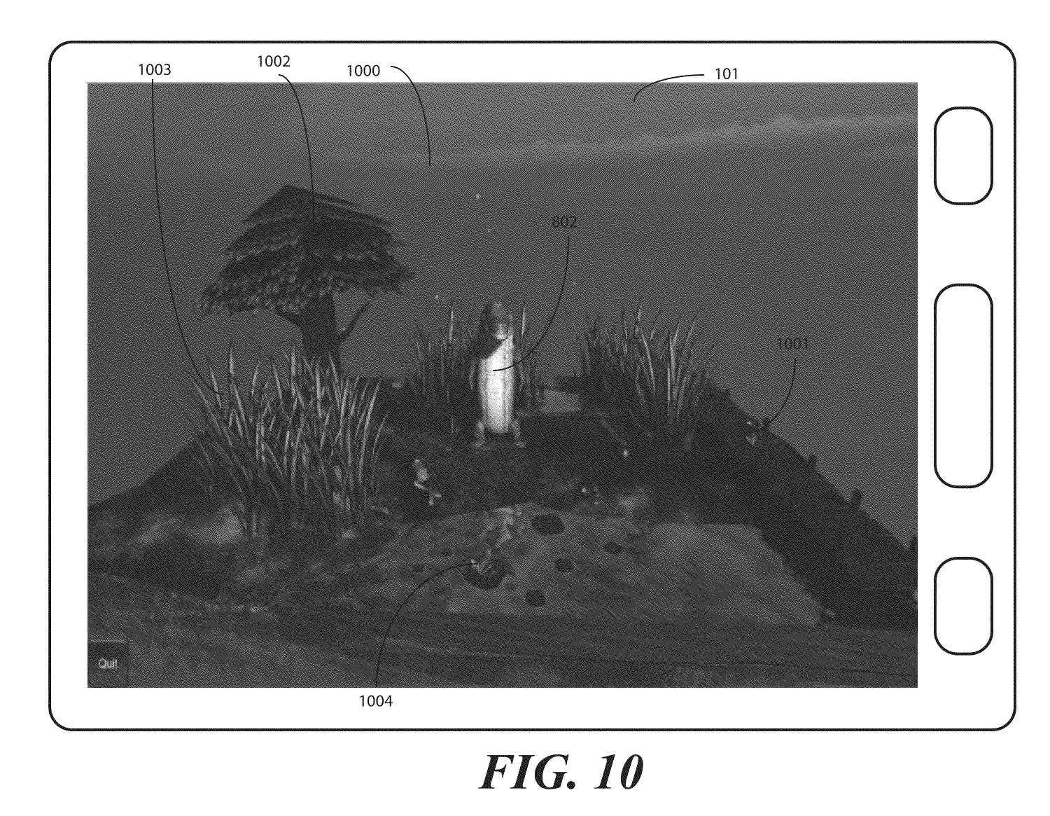

Turning to FIG. 10, illustrated therein is one three-dimensional interactive rendering 1000 filling the display 101, and therefore replacing images of the electronic interactive book (400), thereby transporting the student into an interactive fantasy world. In this illustrative embodiment, the three-dimensional interactive rendering 1000 shows Amos standing in a section 1001 of his swamp home. The three-dimensional interactive rendering 1000 can include additional elements as well, such as trees 1002, grasses 1003, other animals 1004, other objects, and so forth. In one embodiment, the three-dimensional interactive rendering 1000 comprises a three-dimensional rendering of art and/or graphics corresponding to the art and/or graphics (402,411) present on the open pages (441,442) of the electronic interactive book (400).

In one embodiment, the three-dimensional interactive rendering 1000 can be modeled by the education module (107) as a three-dimensional model that is created by the three-dimensional figure generation program. In another embodiment, the three-dimensional interactive rendering 1000 can be stored in memory as a pre-defined three-dimensional model that is retrieved by the three-dimensional figure generation program. The education module (107) can be configured so that the elements present in the three-dimensional interactive rendering 1000, e.g., animals 1004, plants 1003, etc., are textured and has an accurate animation of how the each element moves. In one embodiment, the education module (107) can be configured to play sound effects. The sounds can be repeated in one embodiment via the keyboard and the background sounds can be toggled on or off.

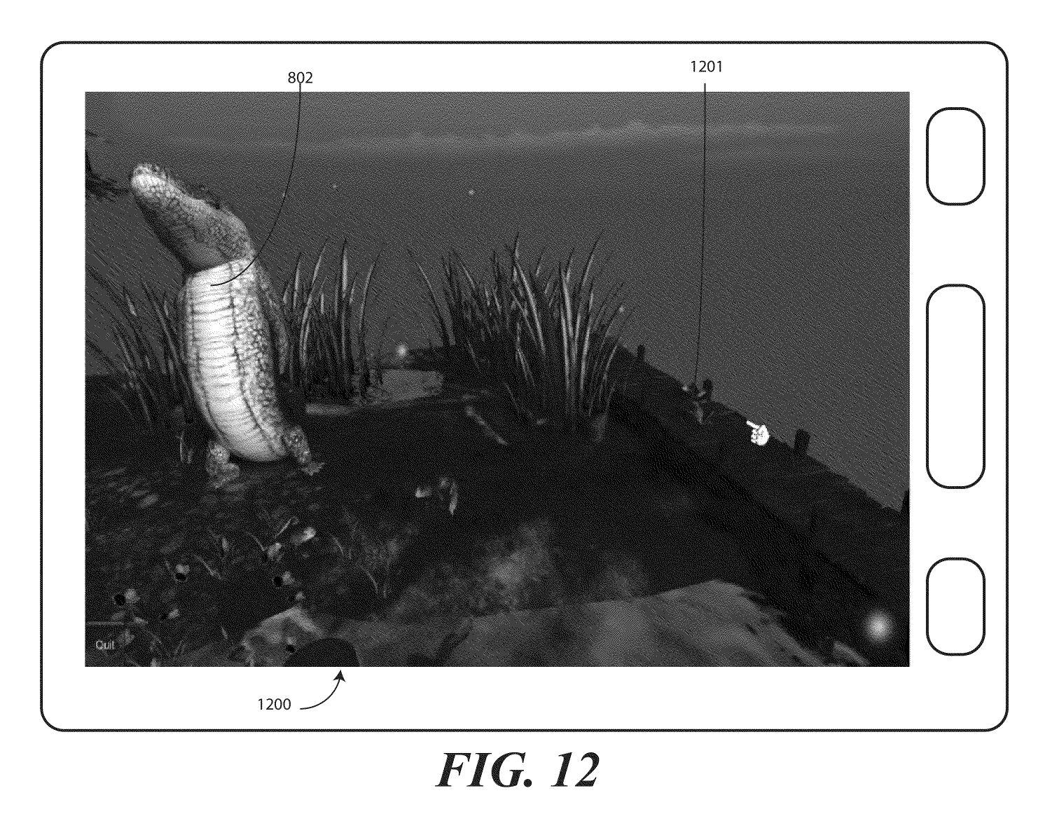

Illustrating by example, the three-dimensional interactive rendering 1000 is Amos 802 standing at his home in a swamp preparing to get ready for a trip. In one or more embodiments, an interactive session can be arranged where the education module (107) prompts the user to find and cover one of the user actuation targets hidden in the three-dimensional interactive rendering 1000. Recall that the text (401,410) on the open pages (441,442) of the electronic interactive book 400 may say, “Amos has a plan, and his map is ready too, but look what Amos has to do! Feed the frogs and trim the weeds, help Amos do the things he needs.” Accordingly, when the three-dimensional interactive rendering 1000 appears, the education module (107) can cause Amos 802 to say, “Help me trim my weeds and feed my frogs, will you?” Where user actuation target is the picture of weeds 1003, covering this user actuation target may cause Amos 802 to swash his tail and cut a three-dimensional rendering of the weeds 1003 present in the three-dimensional interactive rendering 1000. While doing so, Amos may say, “Those weeds are really tall, they do need cutting!” Similarly, turning to FIG. 10, where a user actuation target is an image of a frog 1004, the user 500 can touch this user actuation target to cause Amos 802 to open a jar of flies (not shown) and feed a corresponding three-dimensional rendering of a frog in the three-dimensional interactive rendering 1000 while saying, “Yep, that one looks awful hungry.” As shown in FIG. 12, this action can be accompanied by a close-up 1200 of Amos 802 and the frog 1201 being fed. This example is explanatory only, as any number of other examples will be obvious to those of ordinary skill in the art having the benefit of this disclosure.

In another example, Amos is shown standing in another location getting ready for a trip. The other objects present with Amos in this three-dimensional interactive rendering may include a suitcase, keys, socks, shoes, plane tickets, a hat, and so forth. The three-dimensional interactive rendering may thus comprise an interactive session in which the student can help Amos pack for his trip. In one embodiment, the student does this by selectively covering user actuation targets in the three-dimensional interactive rendering. The education module (107) may cause Amos to say, “Will you help me pack? What do you think I need?” One user actuation target may correspond to Amos's plane tickets. When the student covers user actuation target, this may cause the tickets present in the three-dimensional interactive rendering to “jump” into Amos's suitcase. Similarly, if a user actuation target corresponds to Amos's shoes, covering this user actuation target can cause the shoes to jump into the suitcase as well.

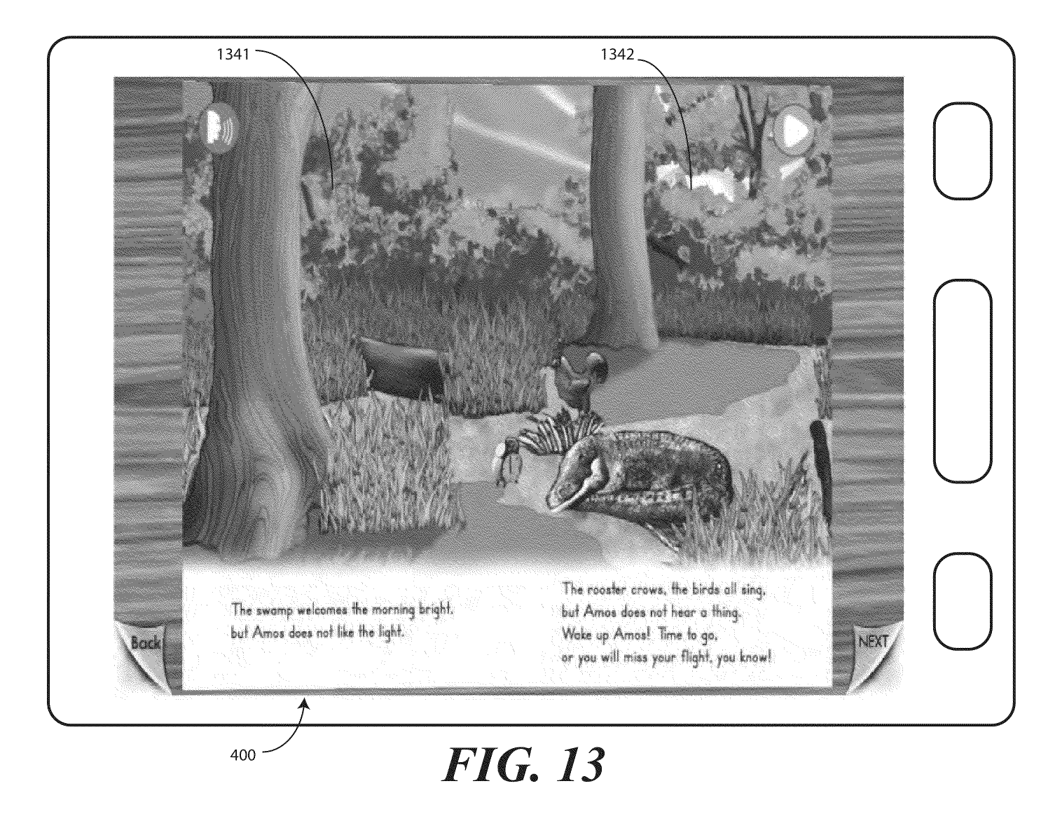

In one embodiment, when each of the items Amos needs for the trip have been found and placed into the suitcase, the three-dimensional interactive rendering is removed thereby allowing the student to transition to the next page. This can be accomplished by presenting a user actuation target similar to user actuation target (303) shown in FIG. 3. In another embodiment, when each of the items Amos needs for the trip have been found and placed into the suitcase, the three-dimensional rendering simply disappears. In yet another embodiment, the user is able to remove the three-dimensional interactive rendering at the time of their choosing by covering a predefined user actuation target. Accordingly, as shown in FIG. 13, new pages 1341,1342 of the electronic interactive book 400 can be revealed.

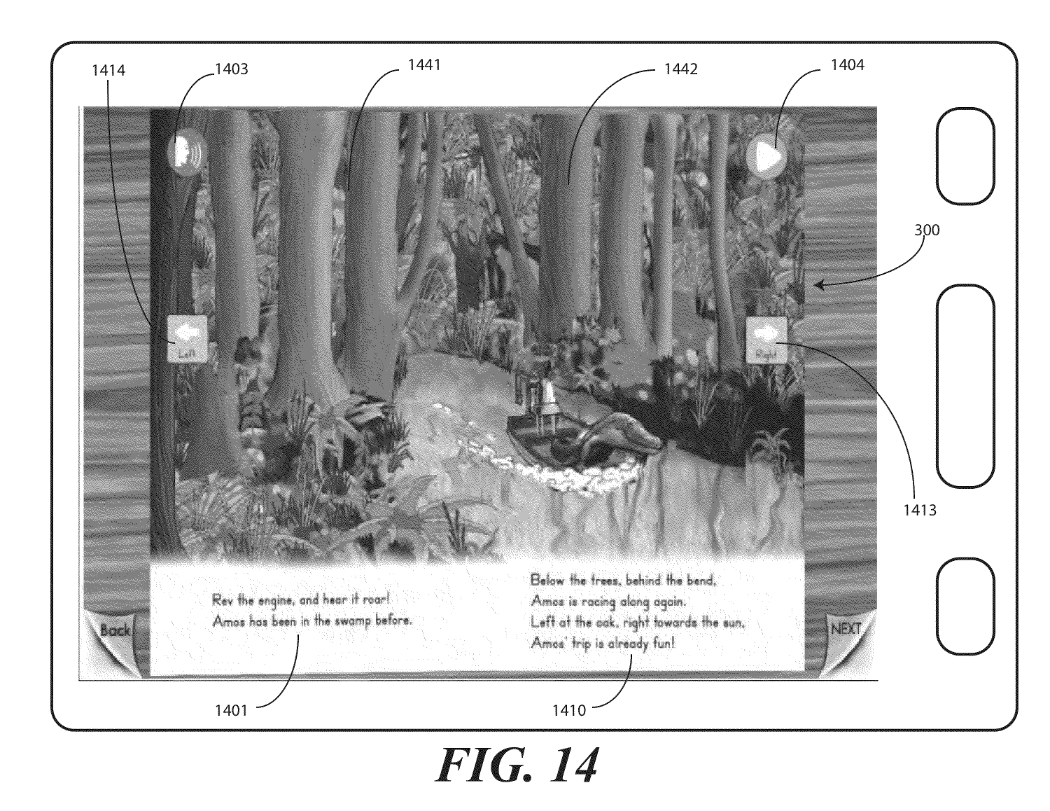

FIGS. 4-12 describe and illustrate an interactive session that can be provided with methods and systems configured in accordance with embodiments of the present invention. However, it will be clear to those of ordinary skill in the art having the benefit of this disclosure that other types of interactive events can be provided as well. Turning now to FIG. 14, illustrated therein is an explanatory alternative interactive event.

The open pages 1441,1442 of the electronic interactive book 400 shown in FIG. 14 correspond to an interactive game. This can be seen by the inclusion of game control user actuation targets 1413,1414. In this illustrative embodiment, game control user actuation target 1413 is a “move right” control, while game control user actuation target 1414 is a “move left” control. While two game controls are shown, it will be clear to those of ordinary skill in the art having the benefit of this disclosure that other numbers and types of game controls could be equally provided. Examples of additional game controls include jump controls, move up controls, move down controls, and so forth.

As with previous open pages (441,442), the open pages 1441,1442 of FIG. 14 include a read text element 1403 and a play element 1404. Other user actuation targets can be included as well. As with previous figures, the user can touch the read text element 1403 to cause the text 1401,1410 to be read by the education module (107).

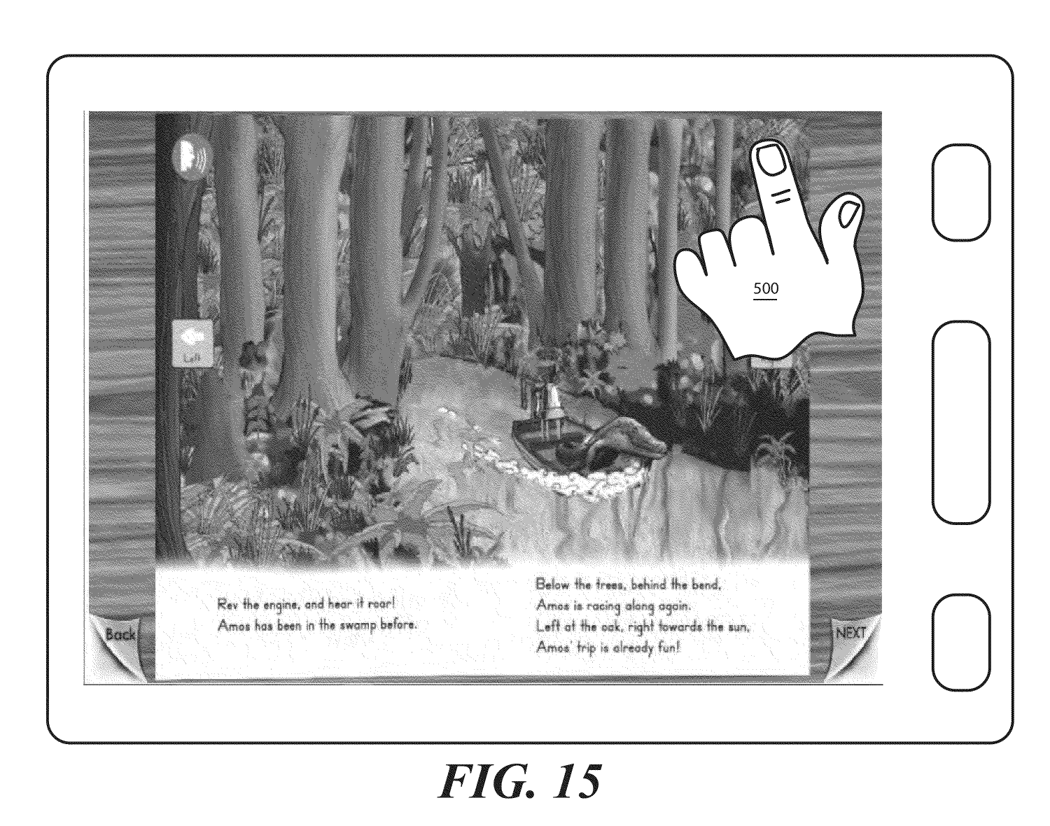

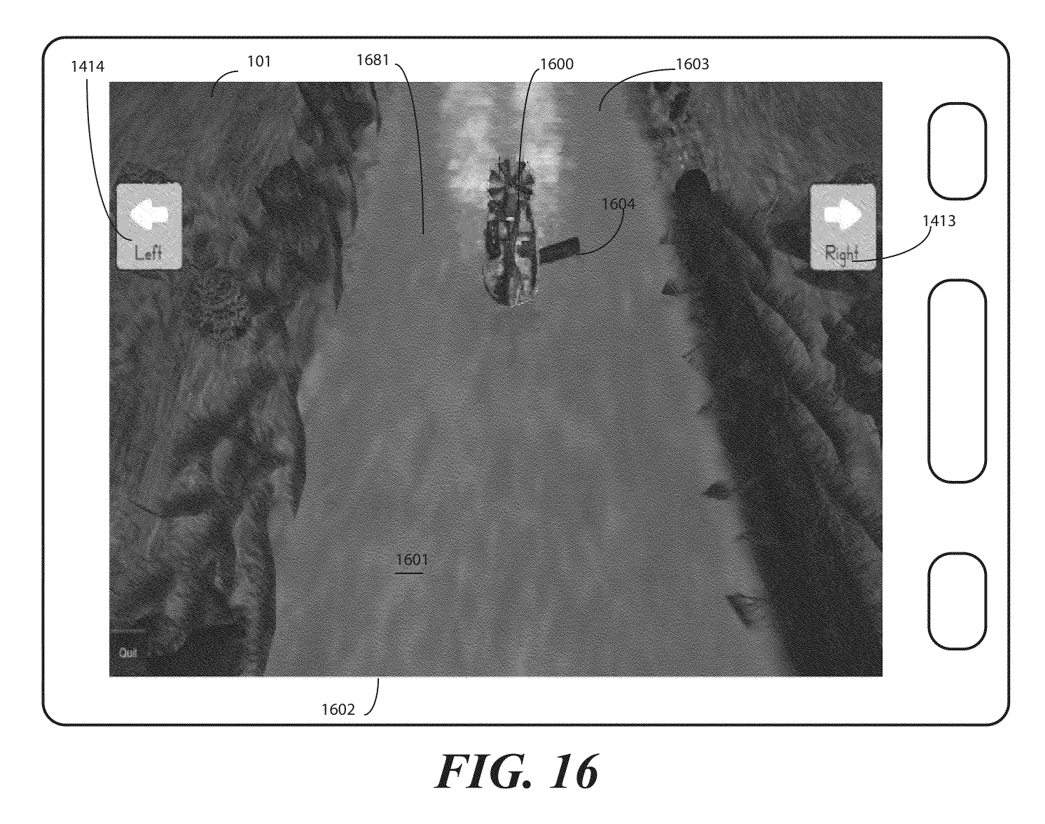

Turning to FIG. 15, when the user 500 touches the play element (1404), the education module (107) can present a three-dimensional game rendering. One explanatory three-dimensional gamer rendering 1681 is shown on the display 101 in FIG. 16. As with previous renderings, the three-dimensional game rendering 1681 is shown in FIG. 16 has replaced the pages (1441,1442) of the electronic interactive book (400).

The three-dimensional game rendering 1681 differs from the interactive sessions above in that an educational game is presented. The game control user actuation targets 1413,1414 can be used to control a character 1600 in a game. In the illustrative embodiment of FIG. 16, the educational game is teaching the directional concepts of right and left. The character 1600 is shown in a boat traversing a river 1601 moving from the foreground 1602 to the background 1602 that is littered with logs 1604. The character 1600 is hitting a log 1604 in FIG. 16. Logs can be present at various points in the river 1601. To successfully navigate the educational game, the user must selectively cover the game control user actuation targets 1413,1414 to move the character right and left to avoid the obstacles.

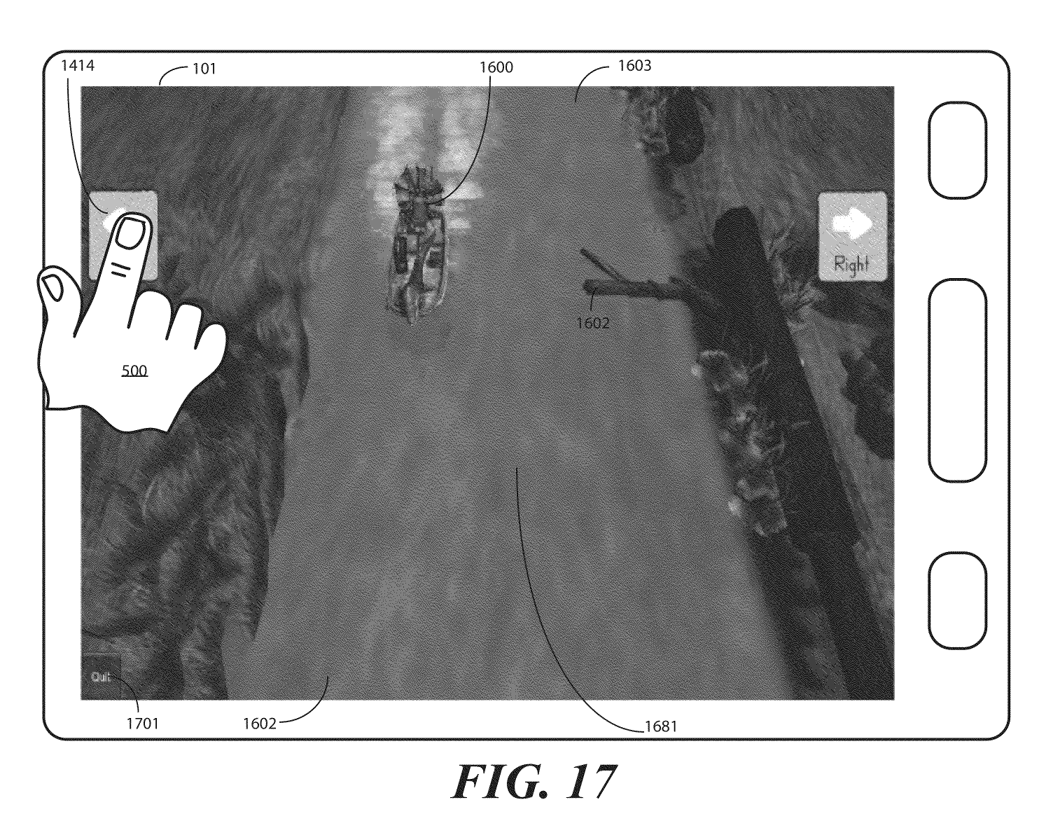

Illustrating by example, turning to FIG. 17, the user 500 has covered the move left game control user actuation target 1414 to cause the character 1600 to move to the left, thereby avoiding the log 1704 as it moves from the foreground 1602 to the background 1603. Once the game is complete, the three-dimensional game rendering 1681 can be removed. In one embodiment, this occurs automatically. In another embodiment, the user may cover another user actuation target 1701 to cause the three-dimensional game rendering 1681 to be removed. Once this occurs, the user 500 is able to turn to another open page of the electronic interactive book (400).

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A computer-implemented method of teaching, comprising:
presenting one or more images of electronic pages of an electronic interactive book; and
in response to actuation of a user actuation target, transforming a presentation on a display of an electronic device with an education module by replacing the one or more images with a three-dimensional interactive rendering corresponding to the one or more images of the electronic interactive book.

2. The method of claim 1, wherein electronic pages of the electronic interactive book have one or more user actuation targets disposed thereon.

3. The method of claim 2, wherein:
the electronic pages further comprise text disposed thereon;
the one or more user actuation targets comprise a read text element; and
when the read text element is actuated, causing with the education module the text to be read aloud.

4. The method of claim 2, wherein:
the one or more user actuation targets comprise a play element; and
the three-dimensional interactive rendering is presented only after the play element is actuated.

5. The method of claim 4, further comprising presenting a cut video after the play element is actuated and before the replacing.

6. The method of claim 1, wherein:
the electronic pages of the electronic interactive book has one or more of art or graphics disposed thereon; and
the three-dimensional interactive rendering comprises a three-dimensional rendering of elements included in the one or more of art or graphics.

7. The method of claim 2, wherein the three-dimensional interactive rendering comprises a character named Amos who is an Alligator.

8. The method of claim 7, further comprising animating Amos when at least one user actuation target of the three-dimensional interactive rendering is actuated.

9. The method of claim 8, further comprising delivering a prompt requesting that the at least one user actuation target be actuated.

10. The method of claim 7, wherein the three-dimensional interactive rendering comprises an interactive game.

11. The method of claim 10, wherein at least one user actuation target comprises a game control user actuation targets.

12. A educational system, comprising:
an education module, stored in a computer readable medium and operable with a control circuit of an electronic device, the education module being configured to:
receive input from a user; and
in response to the input, replace images of electronic pages of an electronic interactive book with a three-dimensional interactive rendering on a display of the electronic device.

13. The educational system of claim 12, wherein the electronic interactive book comprises reading instructional materials.

14. The educational system of claim 12, wherein the electronic pages of the electronic interactive book comprise user actuation targets, wherein the user actuation targets comprise a read text element and a play element.

15. The educational system of claim 14, wherein the education module is configured to read text from the electronic pages of the electronic interactive book when the read text element is actuated.

16. The educational system of claim 14, wherein the education module is configured to present the three-dimensional interactive rendering on the display only after the play element is actuated.

17. The educational system of claim 16, wherein the education module is configured to present a cut video on the display after the play element is actuated and before the three-dimensional interactive rendering is presented.

18. The educational system of claim 12, wherein:
the electronic pages of the electronic interactive book comprise user actuation targets, wherein the user actuation targets comprise a read text element and a play element;
the education module is configured to read text from the electronic pages of the electronic interactive book when the read text element is actuated; and
the education module is configured to present the three-dimensional interactive rendering on the display only after both the text has been read and the play element has been actuated.

19. The educational system of claim 12, wherein the education module is configured to animate one or more elements of the three-dimensional interactive rendering when one or more user actuation targets in the three-dimensional interactive rendering have been actuated.

20. The educational system of claim 12, wherein the three-dimensional interactive rendering comprises a three-dimensional rendering removal user actuation target, wherein the education module is configured to preclude usage of the three-dimensional rendering removal user actuation target until a predetermined criterion is met.
